(19) United States
(12) Patent Application Publication
(10) Pub. No.: US 2013/0197942 A1
(43) Pub. Date: Aug. 1, 2013

(54) DYNAMIC RISK MANAGEMENT AND RESOURCE ALLOCATION AND TREATMENT SYSTEM AND METHOD

(71) Applicant: Ross Medical Corporation, Manhattan, NY (US)

(72) Inventors: Alexander Ross Chiu, Oakland, CA (US); Alexander Douglas Fahrenbach, Oakland, CA (US)

(73) Assignee: ROSS MEDICAL CORPORATION, Manhattan, NY (US)

(21) Appl. No.: 13/753,503

(22) Filed: Jan. 29, 2013

Related U.S. Application Data
(60) Provisional application No. 61/592,196, filed on Jan. 30, 2012.

(51) Int. Cl. G06F 19/00; G06Q 50/22

(52) U.S. Cl. CPC G06F 19/3431; G06Q 50/22
USPC 705/3

(57) ABSTRACT

A dynamic risk management system for use in providing remote medical management services is disclosed and described. The system includes a database and at least one processor that is programmed to calculate a dynamic risk score for each patient in a plurality of patients. The dynamic risk score is calculated continuously and receives real time data related to the patients. Based on each patient's risk score, patient care resources are dynamically allocated to the patient population and/or treatment decisions are made for the patients.

### CROSS-REFERENCE TO RELATED APPLICATIONS

This application claims the benefit of U.S. Provisional Patent Application No. 61/592,196, filed on Jan. 30, 2012, the entirety of which is hereby incorporated by reference.

### FIELD

This disclosure relates to a system for dynamically reallocating patient care resources based on a dynamically updated risk of certain patient outcomes. It is particularly useful for remote medical management systems in which medical care coordinators and other patient care resources are located remotely from a dispersed patient population.

### BACKGROUND

As health care costs continue to rise, it becomes increasingly desirable to minimize the length of time patients must be hospitalized while still ensuring that they receive the appropriate degree of care. Centralized remote medical management systems are a possible solution for reducing the necessity and length of hospital stays and could allow patients to remain at home while still being monitored by remotely located medical care coordinators. However, centralized remote medical management of patients with different diagnostic and geographic needs introduces a new problem. The risk and response for each patient managed by a standard remote call center is not tailored to the patient's specific needs. To offer this standard of care provided in a hospital, a new method of managing real time risk and response is needed.

In hospital settings the initial static patient risk is determined on triage and the basic medical screening examination by a doctor. Through the patient's history, vital signs, physical examinations, and test results, patients are triaged for different risk levels. This risk is defined using word descriptions (e.g., “high,” “low,” “moderate,” not quantified) from the experience and Gestalt of the medical professionals taking care of the patient.

High risk patients go to the intensive care unit (ICU), which typically has a high nurse to patient ratio (relative to other hospital areas), high yield dynamic monitoring, proximity to specific medical staff, and sensors and computer algorithms for monitoring those sensors and alarms. These patient care resources are all allocated to patients based on the risk and potential required response for that patient and are periodically reallocated among the ICU patients as their respective risk and potential response profiles change. If another, higher risk patient gets admitted to the ICU, the above resource allocation changes. Even the type of nurse and doctor that are responsible and location of patient may be changed in response to risk and response profile changes. Location is a particularly important aspect of patient care resources in the hospital setting because it dictates who will respond and what resources are available in the event a patient experiences a medical event, such as a heart attack or stroke, for example. A room in front of a cardiac nurse adjacent to a medication code crash cart is best suited for patients with high risk cardiac conditions.

It is desirable to attempt to replicate the current standard of care applicable to hospital patients to those whose care is managed by a remote medical management system. In certain examples of such systems, all patient care decisions are filtered through one call center, which is located remotely from the patients and serves as essentially the same resource for each of them. Yet, it would be impractical to offer all remotely managed patients the highest level of remote care (ICU like care with high staff ratios). A ratio of two patients to one nurse and one doctor to five patients would be cost prohibitive and an inappropriate allocation of resources for patients who present little risk of adverse medical events. Also, with respect to managing large numbers of geographically-disperse patients, resource allocation cannot be feasibly done by humans alone because it requires real time processing of a much larger amount of data continuously than would be required in smaller, local patient population such as is found in a hospital. Thus, a need has arisen for a dynamic risk management and resource allocation system.

### BRIEF DESCRIPTION OF THE DRAWINGS

Referring now to the drawings, illustrative embodiments are shown in detail. Although the drawings represent some embodiments, the drawings are not necessarily to scale and certain features may be exaggerated, removed, or partially sectioned to better illustrate and explain the present invention. Further, the embodiments set forth herein are exemplary and are not intended to be exhaustive or otherwise limit or restrict the claims to the precise forms and configurations shown in the drawings and disclosed in the following detailed description.

FIG. 1 is a depiction of an exemplary remote medical management system that includes a system for dynamically allocating patient care resources to patients located remotely from medical care coordinators;

FIG. 2 is a depiction of the components of the server farm and remote call center of FIG. 1;

FIG. 3 is a flow chart depicting a first exemplary method of dynamically allocating patient care resources to patients located remotely from medical care coordinators;

FIG. 4 is a flow chart depicting a second exemplary method of dynamically allocating patient care resources to patients located remotely from medical care coordinators; and

FIG. 5 is a flow chart depicting an exemplary method of dynamically updating a patient risk model used to dynamically allocate resources to patients located remotely from medical care coordinators.

### DETAILED DESCRIPTION

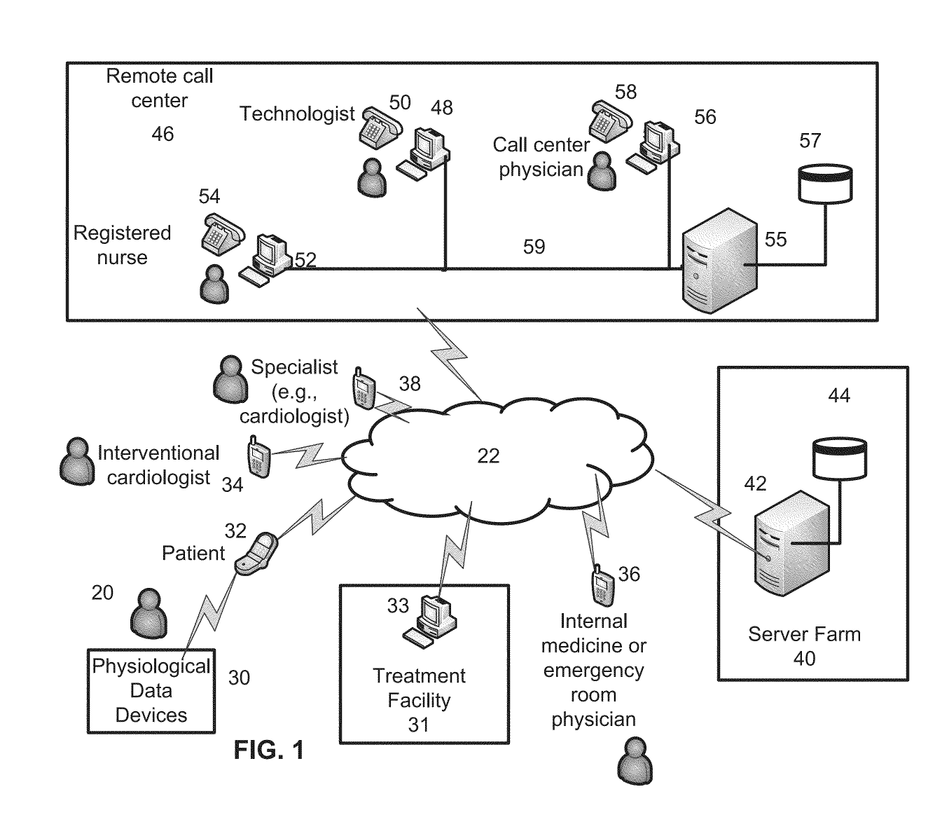

Referring to FIG. 1, a system 20 for providing remote medical management services to patients is provided. In preferred examples, the patients are located remotely from medical care coordinators, i.e., they are not admitted patients in a medical facility staffed by the medical care coordinators, even though they may visit medical facilities as part of their daily routine. The remote medical care coordinators may be hundreds of miles from the patients or even in another state or country than the patients. In the same or other preferred examples, the patients are located remotely from a call center that includes medical care coordinators that monitor the medical condition of and/or make treatment decisions for the patients. As discussed below, system 20 includes a system for dynamically allocating patient care resources to and/or identifying treatments for the patients who subscribe to the system 20. In certain examples patient care resources are dynamically reallocated by calculating risk scores for the patients which are indicative of a particular patient outcome and reallocating the patient care resources based on the risk scores. In the same or other examples, treatments are dynamically determined by calculating risk scores for patients which are indicative of a particular patient outcomes. In further examples, orders for resources and treatments are executed automatically by system 20 without requiring human intervention.

In certain examples, the risk scores are continuously calculated and updated at defined intervals, and resource reallocation and/or treatment determinations are continuously made at defined intervals. Thus, changes in patient data for the subscribed patient population are received in real time (i.e., as soon as they are available accounting for data transmission delays) and used to make real time updates to patient risk scores. In the same or other examples, the risk scores are calculated not only based on patient data, but also based on patient care resource data, in which case the risk scores account for the availability or lack of availability of resources to treat or mitigate the patient outcome. Thus, system 20 allows a set of patient care resources to be continually reallocated to and/or treatment decisions to continually be made for a large, geographically disperse patient population. The program risk scores may also to be transmitted to medical care coordinator computer terminals 48, 52, 56 for viewing. The risk scores are preferably calculated by executing a set of computer executable instructions on a processor. The dynamic resource allocation determinations and treatment determinations are also preferably made by executing a set of computer executable instructions on a processor.

System 20 comprises one or more physiological data devices 30 used to make various physiological measurements of the patient, a remote call center 46, and a computer network 22, which is preferably a wide area network (“WAN”) and even more preferably the internet. System 20 allows a medical care coordinator located in call center 46 to monitor the medical condition of and/or make medical treatment decisions for patients subscribed to system 20. System 20 also includes patient communication devices 32, physician communication devices 34, 36, and 38, a plurality of treatment facilities (shown as a single treatment facility 31), and a server farm 40.

System 20 is particularly useful for patients who must be closely monitored and routinely tested due to a known medical condition, such as cardiac disease, diabetes, etc. The range of medical conditions for which system 20 may be used is not limited. In one implementation, a patient subscribes to use system 20 and is associated with one or more call centers 46 used to monitor the patient's after care following his or her release from a medical facility. Call center 46 is staffed with one or more medical care coordinators who monitor the subscribing patients' medical conditions by tracking physiological data transmitted from the patient to the call center 46 via computer network 22. The medical care coordinators may have different levels of experience, training, and/or specialization. They may also be qualified to monitor different patient risk levels and to handle different patient loads (e.g., numbers of patients per coordinator). In the example of FIG. 1, the call center 46 includes registered nurses, technologists, and physicians.

Call center 46 may comprise a single building or a plurality of buildings, which may be co-located or geographically disperse. The medical care coordinators in call center 46 receive information concerning potential medical events being experienced by the patients they serve and may diagnose the patient's condition based on the received data and/or based on communications with the patient. Each medical care coordinator has access to at least one phone and at least one computer terminal. In the example of FIG. 1, remote call center 46 includes at least one registered nurse computer terminal 52 and phone 54, at least one technologist computer terminal 48, and phone 50, and at least one physician computer terminal 56 and phone 58. The call center 46 may also include at least one call center server 55 and at least one call center database 57 which are in communication with the computer terminals 48, 52, and 56 via network 59. The computer terminals may be complete computers, each having a processor, memory, and one or more storage devices. They also may be dummy terminals configured to receive and transmit data to the at least one call center server 55. Exemplary computer terminals 48, 52, and 56 include desktop computers, laptop computers, tablets, and smart phones.

The medical care coordinators may also enlist the aid of a physician or other third party located remotely from call center 46 to provide diagnostic assistance and/or treatment instructions. In certain preferred examples, patients subscribing to system 20 are assigned to one or more on-call physicians located remotely from the patients and call center 46 to provide testing and treatment orders as well as levels of diagnostic expertise that cannot be provided by the medical care coordinators. As shown in FIG. 1, such on-call physicians include internal medicine or emergency room physicians, interventional cardiologists, and specialists (e.g., a cardiologist). In the example of FIG. 1, an interventional cardiologist is one who would actually perform a procedure (e.g., a cardiac catheterization procedure) on the patient if circumstances require it. System 20 may also be equipped to provide emergency response services of the type disclosed in applicant's co-pending U.S. patent application Ser. No. 13/082,775, entitled “Improved Patient Emergency Response System,” the entirety of which his hereby incorporated by reference.

In system 20 one or more physiological data devices 30 are provided for each patient which detect physiological data for the patient and transmit the data to a communication device 32 via either wireless or wired connections. Communication device 32 then transmits the physiological data to one of the medical care coordinator terminals 48, 52, 56, server farm 40, physician communication devices 34, 36, 38, and/or treatment facility terminal 33 via computer network 22.

A variety of known physiological data devices 30 may be used to measure physiological data such as ECG data, implantable cardioverter defibrillator data, blood vessel impedance data, intra-cardiac pressure sensor data, ultrasound data, intracranial pressure sensor data, pulse oximetry data, co-oximeter sensor data, light absorbance data, glucometer data, EEG data, and endovascular graph sensor data, to name a few. Suitable physiological data devices 30 configured to transmit data to communication device 32 include those supplied by Card Guard Scientific Survival, Ltd., of Rehovot, Israel and QRS Diagnostic of Maple Grove, Minn. Other suppliers of such physiological data devices include Nasiff Associates, Inc. of Central Square, N.Y. For wireless implementations, the physiological data devices 30 will preferably include a wireless transmitter configured to wirelessly transmit data to patient communication device 32. Wireless communications between physiological data devices 30 and patient communication device 32 may be provided using various protocols and other wireless technologies, including 3G and 4G wireless technologies and the IEEE series of wireless technologies. More particularly, wireless communications may take place over a CDMA, EDGE, EV-DO, GPRS, GSM, UMTS, W-CDMA, or a 1xRTT network as well as an IEEE 802.11 (WiFi), 802.15 (Bluetooth and Zigbee), 802.16 (WiMax) or 802.20 (MBWA) network. Patient communication device 32 acts as a gateway to computer network 22. Suitable communication devices 32 will be capable of wirelessly communicating with one or more internet servers. Suitable communication devices 32 include wireless transmitters and include cellular telephones, smart phones, tablet computers, laptop computers, desktop computers with wireless modems, etc.

In cases where wireless transmission between patient communication device 32 and computer network 22 cannot be achieved or is transient—such as in the case of the patient living in the basement or out of wireless range—an additional device, such as a wireless router, can be integrated to send the data via wired transmission to internet cloud 22. One such exemplary router is the GAC 150 WiFi dial up router supplied by Great Arbor Communications of Potomac, Md. In such cases, the patient plugs the router into a phone jack or an existing Ethernet port. When the reception is weak the patient communication device will switch to WiFi and look for the router signal. If the router is connected to an Ethernet port, it will transfer the data through the patient's own wired internet connection (e.g., home broadband cable or DSL connection). If the router is connected to the phone line, when the router senses a WiFi connection from the phone, it automatically dials the “dial up services” to get a 54K dial up connection.

In other cases, a patient may live in a rural area without phone or internet service. In such cases, the patient is provided with a wireless network extender that connects to patient communication device 32 via WiFi and is able to transmit data and voice over satellite. In this scenario, the patient communication device 32 preferably has a direct line of sight to the sky (i.e., a window).

In one exemplary implementation, each patient will be assigned to a medical care coordinator in the remote call center 46. The medical care coordinator will be responsible for communicating with the patient regarding patient medical issues, coordinating the communication of treatment instructions from other medical care coordinators located outside of the call center 46 (such as the interventional cardiologist or internal medicine or emergency room physician shown in FIG. 1), and monitoring real time data transmitted by the patient physiological devices 30. In general, each patient will also be assigned to one or more on-call medical caregivers located remotely from the patient and the remote call center 46. Such on-call medical caregivers include, for example, internal medicine or emergency room physicians and possibly specialists or interventional specialists (e.g., an interventional cardiologist).

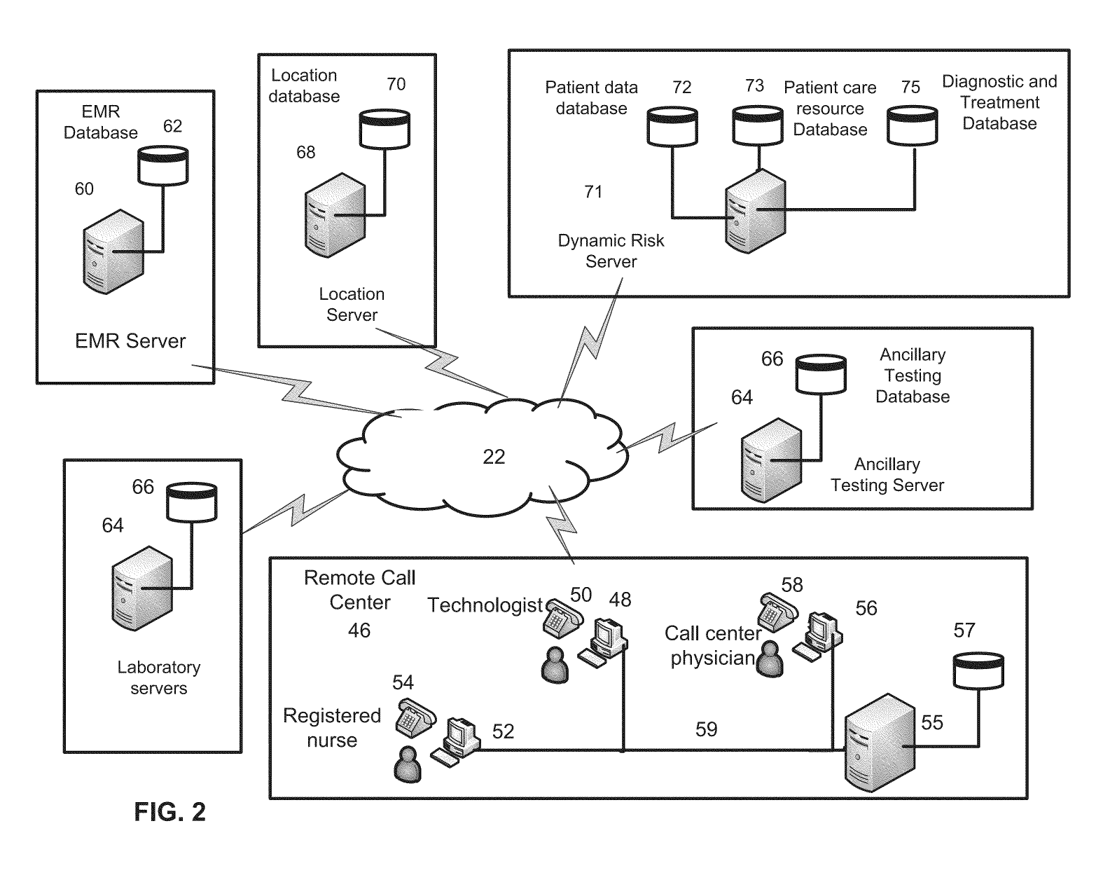

The server farm 40 includes a plurality of servers 42 and databases 44 associated with the servers 42. In one example, different servers are provided which perform different functions. As shown in FIG. 2, in one example of system 20, server farm 40 includes an electronic medical records (EMR) server 60 that is in communication with an EMR database 62. The EMR database 60 includes each patient's medical records in electronic format and may include patient medical data and patient lifestyle data. Patient medical data may include items such as laboratory test results, physiological data from physiological data devices 30 or devices outside of system 20, medication history, known allergies, surgery history, and scheduled medical tests. Ancillary testing database 66 stores raw physiological data. The raw data in ancillary testing database 66 is then interpreted and in some cases selectively provided to the EMR database 60 via communication between ancillary testing server 64 and EMR server 60. In general, medical caregivers, preferably physicians, will interpret raw data in the ancillary testing database 66 and provide interpretations and/or selected portions of the raw data that will be stored in EMR database 62. One example of an ancillary testing database 66 is an echocardiogram testing server which will retain all of the images and videos from echocardiogram testing. Ancillary testing database 66 may be connected to third party test data servers at local testing facilities (e.g., hospitals or doctor's offices) and configured to either receive or retrieve the necessary ancillary testing data from them. In certain examples, the third party test data servers will be programmed to identify whether a given test subject is a subscriber patient for system 20 so that the third-party test data server can automatically upload the patient's test data to ancillary testing server 64 for storage in ancillary testing database 66. A similar configuration and method can be used for providing laboratory data generated by third party laboratories to laboratory server 64 and its associated laboratory testing database 66.

Patient lifestyle data stored in EMR database 62 may include weight data, age data, dietary data, smoking history data, alcohol consumption data, exercise habits, high risk activity data, etc. The EMR database 60 may be provided on a storage device that is local to EMR Server 60 (e.g., a hard drive), or removable media that may be placed in selective communication with EMR Server 60. It may also be provided on a networked storage device that is not local to the EMR Server 60.

Server farm 40 may also include a location server 68 that is in communication with location database 70. Location database 70 may include a variety of patient location information, including the home addresses, work addresses, addresses of frequented locations, physician addresses, etc. as well as schedule information indicative of when a patient is likely to be found at any of his or her locations. Location database 70 may also include a plurality of resource maps that define directions and distances between treatment facilities or medical caregivers and the locations associated with the patient in location database 70. Location database 70 may also include global positioning coordinate histories such as files that include time stamps and corresponding global positioning coordinates as determined by a global positioning system device carried by the patient. In some cases, the patient communication device 32 may include such a global positioning system device. The location database 70 may be provided on a storage device that is local to location server 68 (e.g., a hard drive), or removable media that may be placed in selective communication with location server 68. The location database 70 may also be provided on a networked storage device that is not local to the location server 68.

In certain examples, location server 68 includes a processor programmed to execute a computer program that “geolocates” the patient. Such a program may use a variety of information included in the location database 70 to predict the patient's location at a given time and day of the week. Examples of geolocation techniques are disclosed in pending U.S. patent application Ser. No. 13/082,775, mentioned previously.

Server Farm 40 may also include a laboratory server 64 and associated laboratory database 66 for receiving and storing patient lab results. In one example, laboratory servers are configured to transmit lab results to the lab server 64 for use by the EMR server 60 and/or dynamic risk server 71.

Dynamic risk server 71 preferably includes or is provided with a computer readable medium with computer instructions programmed on it which are executable by the server 70 processor. In certain examples, the computer executable instructions calculate a risk score indicative of the risk of a particular patient outcome for patients utilizing system 20. In the same or other cases, the computer executable instructions identify an allocation of patient care resources for each patient based at least in part on the patient's risk score. In the same or other examples, the computer executable instructions identify a treatment for each patient based at least in part on the patient's risk score. Of course, the illustrated architecture is merely exemplary, and other more distributed or centralized server architectures may be used. For example, separate servers could be provided to calculate patient risk scores and to identify allocations of patient care resources or identify patient treatments.

Patient data database 72 may include a variety of patient data used by the computer instructions that are executed by dynamic risk server 71 to calculate patient risk scores. The data in the patient data database 72 may be collected from other databases, including the EMR database 62, laboratory database 66, location database 70, and/or remote call center database 57. Alternatively, the computer executable instructions may cause dynamic risk server 71 to retrieve patient data directly from other databases instead of first storing it in the patient data database 72. One advantage to storing the patient data in the patient data database 72 is that it facilitates collection and tracking of the historical patient data that was used to calculate historical risk scores.

Patient care resource database 73 may include data related to the resources used to monitor and/or treat patients, including, profiles for call center medical care coordinators, schedules of on-call physicians, specialists, interventional specialists, and/or call center medical care coordinators, treatment facility schedules, percent utilization data for on-call physicians, specialists, interventional specialists, and/or call center medical care coordinators. The profiles of medical care coordinators may include a variety of profile data related to the training level, skill level, and patient load capacity of various medical care coordinators. In one example, the profile data includes a level field (e.g., nurse, physician, technologist), a medical area of competence field (e.g., cardiology, diabetes, asthma), a maximum patient risk level field indicative of the maximum risk level of patient that the medical care giver or medical care coordinator can provide, and a patient load capacity. For example, a particular physician may have a level of PHYSICIAN, a maximum patient risk level of HIGH RISK, and a patient load capacity of a 1:5 physician to patient ratio. Individual medical caregivers may also have different patient load capacities for different risk levels. For example, a technologist may have a load capacity of 1:20 technologist to patient ratio for LOW RISK patients but a load capacity of only 1:5 for MEDIUM RISK patients.

The computer executable program instructions that are executed by the dynamic risk server 71 include instructions to receive patient data for a plurality of patients and calculate one or more risk scores for each patient in the plurality of patients, with each risk score being indicative of a particular patient outcome or set of patient outcomes. The risk scores are indicative of the likelihood of one or more particular patient outcomes occurring. Patient outcomes include medical events, and in particular, include adverse medical events. Exemplary patient outcomes that are medical events include cardiac arrhythmia, syncope (fainting), myocardial infarction (heart attack), pulmonary embolus, stroke, subarachnoid hemorrhage, significant hemorrhage or anemia requiring transfusion, a procedural intervention requirement, severe recurrent ischemia, and death. Certain patient outcomes are not specific medical events, but rather, are specific medical diagnoses, such as acute coronary syndrome or diabetes. Other patient outcomes are non-medical outcomes, such as a return to hospitalization, a patient's increased length of subscription to remote medical management system 20, increased volume of calls to remote call center 46 (FIGS. 1 and 2), increased likelihood loss or misuse of hardware (e.g., patient physiological data devices 30 or communication devices 32), particular delays in treatment, and increased likelihood of missed appointments or late arrival to appointments. In certain examples, patient outcome data is represented as the probability of the outcome occurring within a particular period of time. Thus, in one example a patient outcome may be specified as a probability of having a heart attack within 14 days or a probability of dying from any cause (“all cause mortality”) within 14 days.

In one example applicable to patients with unstable angina and non-ST elevation myocardial infarction, a risk score of 0 to 1 indicates a 5% chance of three patient outcomes within 14 days: 1) death, 2) a new or recurrent myocardial infarction, or 3) severe or recurrent ischemia requiring urgent revascularization. A risk score of 2 indicates an 8% chance of these outcomes, while a risk score of 3 indicates a 16% risk. A risk score of 7 indicates a 41% chance of these outcomes. In another example, applicable to patients with ST elevation myocardial infarction, a risk score of 0 to 1 indicates a 1.6% risk of death at 30 days, a risk score of 2 indicates a 2.2% risk of death at 30 days, and a risk score of 4 indicates a 4.4% risk of death at 30 days. Other examples of patient outcomes that may be indicated by the risk score include the number of calls the patient is expected to make to the call center 46.

In certain examples, risk scores are calculated based on both patient data and patient care resource data. Patient care resource data is data related to the availability of resources that can be deployed to mitigate the risk of a particular patient outcome. Thus, in accordance with such examples, a patient's risk score for a particular outcome will reflect not only the condition of the patient but also the likelihood that the patient can be successfully treated. For example, a patient with acute coronary syndrome may have a higher likelihood of death during periods of time in which no catheterization labs that are within a specified distance of the patient are open. Thus, both patient data (as reflected in the acute coronary syndrome diagnosis) and patient care resource data (as reflected in the availability of close catheterization lab facilities) are used to calculate a risk of death. In the example of FIG. 2, a set of computer executable instructions executed by a processor in dynamic risk server 21 would calculate a risk score based on data in the patient data database 72 and the patient care resource database 73.

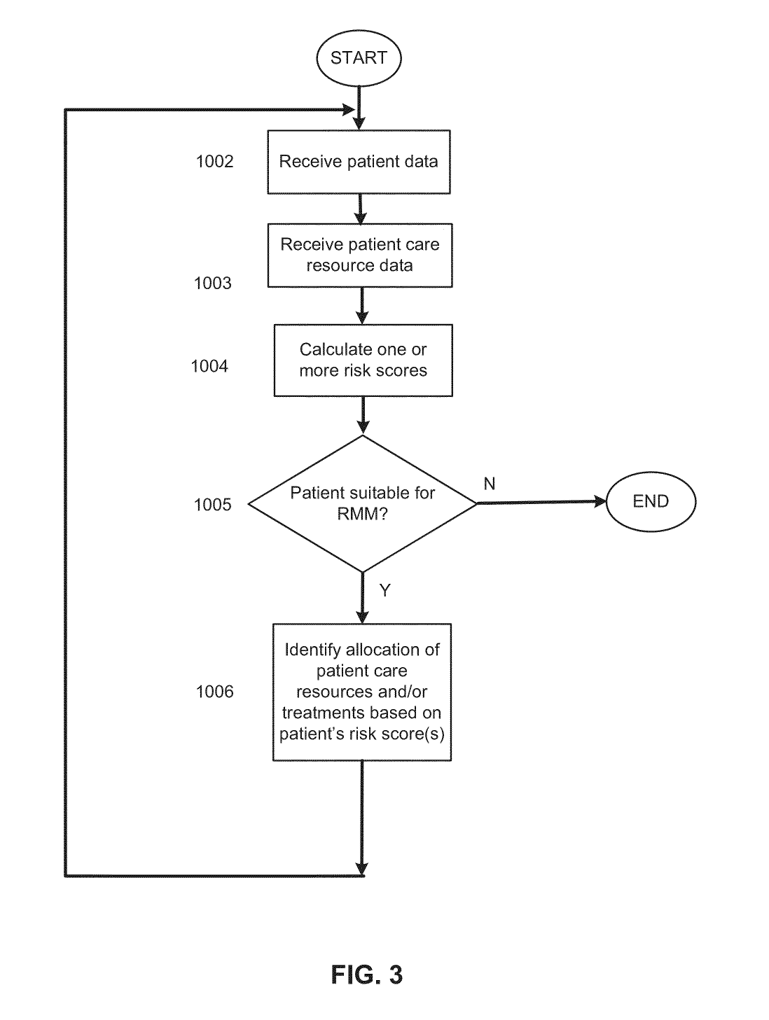

In one example, dynamic risk server 71 includes (or is selectively connected to) a computer readable medium with computer executable instructions stored on it which perform the steps in FIG. 3. In accordance with the figure, in step 1002 patient data (e.g., patient medical data and patient location data) is received. In step 1003 patient care resource data is received. In certain examples, dynamic risk server 71 retrieves the patient data from patient data database 72. In other examples, dynamic risk server 71 retrieves the patient data directly from other databases (e.g., EMR database 62 and laboratory database 66). In step 1004 one or more risk scores, each indicative of one or more patient outcomes, is calculated based on the patient data and patient care resource data. In certain cases, a patient's risk score may indicate that he or she is unsuitable for remote medical management, for example, because the patient requires a higher level of care than can be provided outside of a hospital setting. This determination is made in step 1005. If the patient is deemed unsuitable, the process ends (as to that patient) because the patient is no longer managed by call center 46. Otherwise, control proceeds to step 1006.

In step 1006, patient care resources are allocated to each patient based on his or her respective risk scores. In certain cases, the patient care resources are allocated by accessing tables in the diagnostic and treatment database 75 that relate risk scores (directly or indirectly) to patient care resources and/or treatments. In certain examples, a single risk score may be related to multiple patient outcomes, which in turn may be related to an allocation of patent care resources and/or treatments.

In certain cases, the computer executable instructions executed by a processor in dynamic risk server 71 may calculate multiple risk scores for an individual patient, wherein each risk score is indicative of a particular patient outcome or sets of patient outcomes. Each patient outcome or set of patient outcomes may in turn be related to an allocation of patient care resources in diagnostic and treatment database 76. In some situations, the multiple risk scores may each correspond to a unique allocation of a particular patient care resource, in which case, the highest resource allocation called for by any of the patient's identified resource allocations would be used. For example, if a risk score 1 called for a patient to be monitored by a call center technologist, while risk score 2 called for the patient to be monitored by a call center physician, the call center physician would be identified as the allocated resource. In another example, if risk score 1 called for non-continuous video monitoring of a patient while risk score 2 called for continuous call center video monitoring of a patient, the patient would receive continuous call center monitoring.

In certain examples, following step 1006 control returns to step 1002 to form a continuous loop of risk score calculations for each patient subscribing to system 20 so that the risk scores are dynamically updated on a continuous basis at periodic intervals. In certain examples, the risk score calculations for each patient are performed at least every hour, preferably at least every half hour, more preferably at least every ten minutes, still more preferably at least every five minutes, and even more preferably at least every 30 seconds. In one example, the risk score calculations are performed at least every second. In another example, the risk score calculations are performed at a frequency that is approximately equal to the fastest frequency of any real time patient data updating. Thus, if the dynamic risk server receives patient physiological data every half second, the risk score calculations would be performed at that frequency.

Risk scores may be calculated from patient data or the other foregoing variables in a variety of ways. In some cases, a threshold value for the data may be set, and exceeding the threshold will incrementally increase the risk score by a certain amount (e.g., +1 or +2). In one example, applicable to patients with unstable angina and non-ST elevation myocardial infarction, two or more occurrences of severe angina within a 24 hour period will increase the risk score by 1, and having an age of 65 years or older will also increase the risk score by 1. In other cases, the data value itself may be appropriately scaled (e.g., multiplied by a scaling factor) in arriving at its contribution to the total risk score for a patient.

In one example, the various pieces of patient data or other data used to calculate a risk score are converted to risk factors that are then linearly combined to arrive at a final score, e.g.:

Risk=Σxᵢwᵢ,for i=1 to n risk factors (1)
where xᵢ is a risk factor based on patient data and/or patient care resource data, and
w₁ is the weight by which the risk factor is multiplied.

As indicated previously, a variety of different data types are used to determine a patient's risk score. Some of the patient data is discrete, for example, data reflecting whether a particular medical event did or did not occur. Some patient data is a continuous value (e.g., an ECG signal). Some data relates indirectly to risk factors and is not in and of itself a risk factor (e.g., physician on-call schedules or resource maps for a patient and locations on the patient's schedule). In such cases, the disparate data types are preferably converted to risk factors (xᵢ) for use in equation (1). For example, discrete data may be assigned a risk factor of 0 or 1. Physician on-call schedules may be compared to current calendar dates and clock times to determine whether a physician is or is not on-call, which represents a discrete status that may be assigned a risk factor of 0 or 1. Resource maps be used to calculate the distance between a patient and a treatment facility, which is a continuous value. Through the use of logistic regression techniques, the various types of patient data can be translated into risk factors and used in equation (1) or other risk score models.

In another example, changes in patient risk scores are continually updated and then added to a patient baseline risk score to calculate a current risk. For example:

Risk=Baseline Risk+Δrisk (2)

Δrisk=Σyᵢwᵢ for i=1 to n incremental risk factors (3)

where yᵢ is an incremental risk factor indicative of the extent to which a particular type of patient data incrementally alters the risk of a particular patient outcome occurring, and
wᵢ is the weight by which the risk factor is multiplied.

In other examples, one or more of the risk factors in equation (1) may be raised to a selected power. In further examples, certain of the risk factors may be multiplied or divided. In other cases, certain risk factors may be multiplied or divided with the result being raised to an exponent. In other cases, logarithms may be used. In general, the numeric value of the risk score is not in itself important. Instead, it is the relationship between the risk scores and the patient outcomes that is important and which is preferably used to dynamically reallocate patient care resources.

The patient data used to calculate the risk of a patient outcome may include patient medical data and patient location data. In certain examples, the patient data used to calculate risk scores may also include at least one of patient age data, patient lifestyle data, patient ethnicity data, and patient occupation data.

Patient medical data used to calculate risk scores may include items such as laboratory test data, patient medical history data (e.g., a history of particular medical conditions), real time physiological data from physiological data devices 30 or historical physiological data from other physiological devices, medication history, recent medical complaints, known allergies, surgery history, and scheduled medical tests. In certain examples, the patient medical data may include data indicative of how provocative the tests are. For example, stress tests may be provocative for cardiac patients because they can trigger a cardiac event, thereby increasing the risk that a patient outcome (e.g., a heart attack or death) may occur. In some cases, the physiological data devices 30 and/or communication device 32 may include an accelerometer, the data from which may be indicative of the patient's propensity for falling. Thus, such accelerometer data is also a class of patient medical data which may be used to calculate risk scores. In each case, the patient data is represented in a numerical fashion and scaled or otherwise translated to account for its affect on the risk of certain patient outcomes occurring.

Patient lifestyle data used to calculate risk scores may include weight data, age data, smoking history data, alcohol consumption data, exercise habits, high risk activity data, etc. The patient location data used to calculate risk scores may include the patient's home address, work address, addresses of friends, relatives, or frequented establishments, physician addresses, and schedules. Patient location data used to calculate risk scores may also include a plurality of resource maps that define directions and distances between the patient and the locations associated with the patient. Patient location data used to calculate risk scores may also include global positioning coordinate histories such as files that include time stamps and corresponding global positioning coordinates as determined by a global positioning system device carried by the patient. In some cases, the patient communication device 32 may include such a global positioning system device. In general, patient location data will be related to a distance from a medical care giver or treatment facility in order to convert the location data to a risk factor.

In certain examples, the risk score is based, at least in part, on patient care resource data to account for the impact that the availability of certain patient care resources may have on the likelihood of a particular patient outcome occurring. In general, patient care resource data is data related to resources available to care for patients and is not necessarily associated with specific patients. One example of patient care resource data is physician on-call schedule data. For example, if a patient experiences a heart attack and no physician is on-call, the risk of a patient outcome (e.g., death) will be higher than if a physician is on call. Thus, when a period of time is reached during which an on-call physician is not available, the patient's risk score would automatically increase to reflect the likelihood that a medical event will result in an adverse patient outcome. Patient care resource data that may be used in calculating risk scores includes physician on-call schedule data, treatment facility schedule data, and available medical care giver profile data (including profile data for on-duty medical care coordinators in remote call center 46). In some cases, calendar and clock information would also be used to translate schedule data into risk factors. In some cases, historical patient data for patient populations outside of system 20 may be used to generate baseline risk scores as well.

Patient data may be related to risk factors via tables stored in patient data database 72 (or any other database that is configured for use in calculating risk scores, including a separate risk factor database). In addition, a given risk factor may rely on intermediate or subsidiary risk factors, such as known risk factors provided by the TIMI or GRACE risk scoring systems. An illustrative example of a table that could be used to relate certain patient data to risk factors for use in formulas such as equation (1) is provided in Table 1, below:

TABLE 1

| | | Risk Factor | Weighted |
|---|---|---|---|
| Patient Data | Risk factor xᵢ | Weight aᵢ | score (xᵢaᵢ) |
| Age >= 65? Yes | Yes = 1; No = 0 | 1 | 1 |
| Aspirin use in the last | Yes = 1; No = 0 | 1 | 1 |
| 7 days? Yes | | | |
| A least 3 risk factors | Yes = 1; No = 0 | 1 | 0 |
| for Coronary Artery | | | |
| Disease (CAD)? No | | | |
| Patient History of | Yes = 1; No = 0 | 1 | 0 |
| Known Coronary | | | |
| Artery Disease | | | |
| (CAD)? No | | | |
| At least 2 angina | Yes = 1; No = 0 | 1 | 0 |
| episodes within the | | | |
| last 24 hrs? No | | | |
| Serum cardiac | Yes = 1; No = 0 | 1 | 0 |
| biomarkers exceed | | | |
| predetermined | | | |
| threshold? No | | | |
| ST changes of at least | Yes = 1; No = 0 | 1 | 0 |
| 0.5 mm on EKG? No | | | |

Thus, the risk score for the data of table 1 (using equation (1)) is 2. In certain examples, the treatment and diagnostic database 75 (or another database) will relate risk scores to the probability of one or more patient outcomes occurring. An exemplary table illustrating this relationship is provided in Table 2:

TABLE 2

| Score | Probability (%) | Time interval | Outcome |
|---|---|---|---|
| 0 | 4.7 | 14 days | all-cause mortality, new or |
| | | | recurrent myocardial infarction, |
| | | | or severe recurrent ischemia |
| | | | requiring urgent revascularization |
| 0 | 1.2 | 14 days | death |
| 1 | 4.7 | 14 days | all-cause mortality, new or |
| | | | recurrent myocardial infarction, |
| | | | or severe recurrent ischemia |
| | | | requiring urgent revascularization |
| 1 | 1.2 | 14 days | death |
| 2 | 8.3 | 14 days | all-cause mortality, new or |
| | | | recurrent myocardial infarction, |
| | | | or severe recurrent ischemia |
| | | | requiring urgent revascularization |
| 3 | 13.2 | 14 days | all-cause mortality, new or |
| | | | recurrent myocardial infarction, |
| | | | or severe recurrent ischemia |
| | | | requiring urgent revascularization |
| 4 | 19.9 | 14 days | all-cause mortality, new or |
| | | | recurrent myocardial infarction, |
| | | | or severe recurrent ischemia |
| | | | requiring urgent revascularization |
| 5 | 26.2 | 14 days | all-cause mortality, new or |
| | | | recurrent myocardial infarction, |
| | | | or severe recurrent ischemia |
| | | | requiring urgent revascularization |
| 6 | 40.9 | 14 days | all-cause mortality, new or |
| | | | recurrent myocardial infarction, |
| | | | or severe recurrent ischemia |
| | | | requiring urgent revascularization |
| 7 | 40.9 | 14 days | all-cause mortality, new or |
| | | | recurrent myocardial infarction, |
| | | | or severe recurrent ischemia |
| | | | requiring urgent revascularization |

Thus, a patient with a risk score of 2 (as calculated from Table 1) would have an 8.3% chance of experiencing all cause mortality, new or recurrent myocardial infarction, or severe recurrent ischemia requiring urgent revascularization within 14 days. Note that in some cases, such as for risk scores of 0 and 1, some of the patient outcomes may be individually associated with a probability number. Thus, a patient with a risk score of 1 has a 4.7% chance of experiencing any of all cause mortality, new or recurrent myocardial infarction, or severe recurrent ischemia requiring urgent revascularization within 14 days and a 1.2% chance of dying within 14 days.

In certain cases, a patient outcome may be an availability of patient care resources. A first patient outcome (such as a medical event) determined based on patient data may be combined with a second patient outcome (such as a specified delay in treatment) based on an availability of patient care resources to arrive at a different patient outcome (or a different probability of the same patient outcome determined from the patient data alone). In one example, interventional specialist on-call schedule data and call center technologist percent utilization may be used with other data to arrive at a patient outcome indicative of a delay in treatment for the patient outcome that is based on patient data alone. An example of a data table relating patient care resource data to risk factors for use in calculating a risk score indicative of the probability of a delay in treatment is provided in Table 3:

TABLE 3

| Patient Care | Other Risk | | Risk | | |
|---|---|---|---|---|---|
| Resource Data | Factor Data | Risk Factor | Factor | | Weight- |
| Input A | to calculate xᵢ | conversion | xᵢ | Weight | ed Score |
| Catheterization | GPS | Number of | 2 | 2 | 4 |
| lab location | coordinates | minutes over | | | |
| | of patient | baseline: Δxᵢ = 1 | | | |
| | | for each | | | |
| | | additional | | | |
| | | minute | | | |
| On call | Current time | Cardiologist | 1 | 1 | 1 |
| Cardiologist | | currently | | | |
| schedule | | scheduled? | | | |
| | | No = 1; Yes = 0 | | | |
| % utilization | Alarm | Increased delay | 1 | 1 | 1 |
| of assigned | stream | in diagnosis | | | |
| technician for | variance | | | | |
| patient A | | | | | |

In Table 3 the GPS coordinates of the patient are a form of patient location data that can be used to calculate a distance to the catheterization lab, as well as a time of travel to reach it (making certain speed assumptions). The alarm stream variance is a type of remote call center data stored in the call center database 57 and is indicative of the probability that the call center 46 or an individual technician will be unable to handle the call volume during peak call volume events, resulting in a delayed diagnosis. The weighted risk score from Table 3 (i.e., 6) can be related to another patient outcome: a delay in treatment relative to a baseline time. One example of a table that could be used in diagnostic and treatment database 76 (or any other database) to relate the risk scores to a delay in treatment is shown in Table 4:

TABLE 4

| | Probability | | |
|---|---|---|---|
| Score | (%) | Time interval | Outcome |
| 0 | 0.01 | 2 days | Delay in treatment |
| 1 | 0.03 | 2 days | Delay in treatment |
| 2 | 0.05 | 2 days | Delay in treatment |
| 3 | 0.1 | 2 days | Delay in treatment |
| 4 | 0.18 | 2 days | Delay in treatment |
| 5 | 0.29 | 2 days | Delay in treatment |
| 6 | 0.7 | 2 days | Delay in treatment |

As table 4 indicates, the various risk scores each correspond to a different probability of a two day delay in treatment. Thus, a risk score of 6 corresponds to a 0.7% chance of a two day delay in treatment.

The sum of the weighted scores can be used to calculate a combined risk score based on patient data and patient care resource availability data. In one example, the risk score from the patient data is given a weight of 10 while the risk score from the patient care resource data is given a weight of 1. Thus, the combined risk would be (2)(10)+6(1)=26, using the exemplary formula of equation (1). This combined risk can then be related to another patient outcome or to a different set of probabilities for the same patient outcome. In this example, the combined risk score from Tables 1 and 3 can be used to calculate the probability of death within two days from any cause:

TABLE 5

| Combined Risk | | | |
|---|---|---|---|
| Score | Probability (%) | Time (days) | Outcome |
| 23 | 0.9 | 2 | All cause mortality |
| 24 | 0.95 | 2 | All cause mortality |
| 25 | 1.0 | 2 | All cause mortality |
| 26 | 1.1 | 2 | All cause mortality |
| 27 | 1.2 | 2 | All cause mortality |
| 28 | 1.25 | 2 | All cause mortality |

Thus, a combined risk score of 26 corresponds to a 1.1 percent probability of dying from any cause within two (2) days. Thus, Tables 1 and 5 each relate risk scores to a probability of death, but the relationships change because Table 5 accounts for the availability of patient care resources to mitigate the patient outcome.

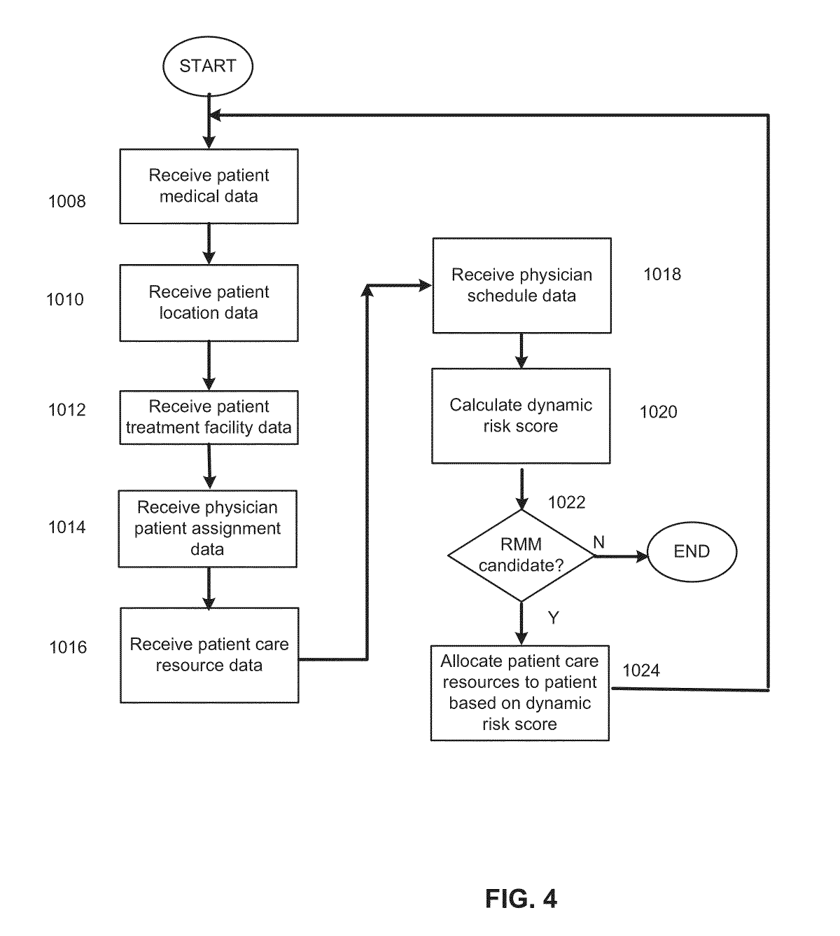

FIG. 4 depicts another example of a method of dynamically allocating patient care resources. The method is preferably carried out by causing a processor in dynamic risk server 71 to execute a set of computer executable instructions that perform the depicted steps. In step 1008 patient medical data for a particular patient is received by dynamic risk server 71. In certain examples, the patient medical data is received from patient data server 72 (which may obtain the data from other databases such as electronic medical records database 62). In step 1010 patient location data is similarly received. In step 1012 patient treatment facility data (which may be classified as a type of patient care resource data) is received. In certain examples the patient treatment facility data is received from patient care resource database 73. In step 1014 physician patient assignment data (1014) (i.e., data concerning which physicians are assigned to a patient which can be used to calculate the physician/patient ratio) is received (e.g., from patient care resource database 73), and physician schedule data (1018) (also a form of patient care resource data) is received by the dynamic risk server 71. Step 1016 represents other forms of patient care resource data that may be received (e.g., lists of on-duty medical care coordinators and their profiles). In step 1020, a risk score is calculated for the patient in the manner described previously. In FIG. 4 and elsewhere herein the term “received” is used to describe the location from which stored data is obtained and not whether the data is retrieved (pulled) by a server seeking the data or transmitted from the server that stores it.

The risk scores described herein can be used to determine whether the particular patient is a suitable candidate for remote medical management. In general, remote medical management is indicated for lower risk patients that require a lower level of care. Thus, in step 1022 a determination is made as to whether the patient is a suitable candidate for remote medical management based, at least in part, on the patient's risk score. If the patient is not a suitable candidate, the method ends. If the patient is a suitable candidate, in step 1024 patient care resources are allocated (or reallocated) based on one or more of the patient's risk scores. Control then returns to step 1008 so that the patient's risk score(s) may be continually updated at a desired interval. As indicated previously, intermediate risk scores may be calculated to arrive at the risk score in step 1020. In some cases, intermediate risk scores may rely only on select types of patient data or patient care resource data. As illustrated above with respect to Table 1, an intermediate risk score may be calculated based on patient data alone and then combined with risk scores calculated from patient care resource data or other types of data to arrive at a combined risk score. It will not necessarily be the case that every type of data shown in steps 1008-1018 will be used to calculate the risk score that is used to allocate patient care resources or determine whether a patient is a remote medical management (RMM) candidate.

As indicated previously, in certain preferred examples, dynamic risk scores for a patient are used to determine how to allocate patient care resources to that patient, and in many cases how to allocate patient care resources among a geographically disperse population of patients subscribing to remote medical management system 20. In the same or other examples, dynamic risk scores for a patient are used to identify treatments to be provided to a patient.

A number of different patient care resource allocation decisions that may be made based on the calculated dynamic risk scores. One example includes the order in which alarms or other patient notifications are handled in call center 46. Such alarms may include alarms indicative of laboratory test results or physiological data that has exceeded a prescribed threshold. In general it is preferable to respond to such alarms and notifications for those patients with a high risk score before responding to them for patients with a relatively lower risk score. For example, if 10 alarms are active for a patient population assigned to a call center registered nurse, five (5) of the alarm notifications may be displayed on computer terminal 52, each corresponding to one of the five patients assigned to her who have the highest risk scores. As an illustrative example, the notification for the patient with the highest alarm score may flash red, while the others may flash other colors (e.g., orange, yellow, green). Other patient care resource allocations include scheduling of tests, consultations, and interventional procedures (e.g., cardiac catheterization procedures). In certain examples, the methods described herein may further comprise actually issuing the necessary orders for testing or interventional procedures to the appropriate service providers, especially for testing or interventional procedures that present a low risk of trauma or the triggering of an adverse medical event.

Another patient care resource allocation determination that may be made based on patient risk scores is the determination as to whether the physiologic data from physiological data devices 30 should be continuously monitored by a human or simply by a computer (with appropriate alarm notifications if predefined thresholds are exceeded). In general, those patients with higher risk scores may require continuous human monitoring of their physiologic data.

Allocating patient care resources may also involve identifying a medical caregiver profile that is suitable for the patient. As mentioned previously, medical care giver profiles may include the caregiver level (e.g., doctor, nurse, technologist), areas of competence (e.g., cardiology, orthopedics, immunology, neurology), and allowable patient risk levels (e.g., low, medium, and high) and patient loading (e.g., ratio of caregiver to number of patients). The patient resource allocation made by dynamic risk server 71 may include determining suitable profiles (or profile portions) for patients. Thus, in one example the dynamic risk server 71 may determine that the patient requires a medical care coordinator at call center 46 that is a technologist suitable for handing low risk cardiac patients in a 1:10 caregiver to patient ratio. In another example, dynamic risk server 71 may determine that the patient requires a medical care coordinator who is a physician capable of monitoring medium risk cardiac patients in a 1:2 caregiver to patient ratio.

In certain examples of the method of FIG. 4, the decision in step 1022 as to whether a patient is a suitable RMM candidate is based, at least in part, on whether a medical care coordinator is available at remote call center 46 who has the level, competence areas, and/or suitable patient load capacity for the patient. If no such coordinator is available, the patient is not enrolled, and the method ends. In certain other examples, the medical care coordinator profiles in patient care resource database 73 are then used to assign patients to particular available medical care coordinators. In one example, a new high risk patient is enrolled and is determined by dynamic risk server 71 to be suitable for monitoring by a technologist. Three technologists are currently on-duty at call center 46, each being assigned five (5) low risk patients. Dynamic risk server 71 determines that one of the three technologists (Technologist 3) is most suited to monitor the new high risk patient. The dynamic risk server 71 reassigns the five low risk patients assigned to Technologist 3 to Technologists 1 and 2 (three to Technologist 1 and two to Technologist 2). Thus, the new medical care coordinator assignment distribution would be Technologist 1 watching 8 patients, Technologist 2 watching 7 patients, and Technologist 3 watching the 1 high risk patient.

In certain examples, medical care coordinator risk levels may be blended based on the coordinator's maximum number of patients per risk level. In one method, the risk level blending is performed by converting the medical care coordinators patient load to a risk equivalent basis load. For example, if a technologist can monitor 3 high risk or 12 low risk patients, then each high risk patient is the equivalent of four (4) low risk patients. Thus, the technologist could be assigned any of the following patient combinations, each of which is equivalent to 12 low risk patients: (i) three (3) high risk patients and no low risk patients, (ii) twelve (12) low risk patients and no high risk patients, (iii) one (1) high risk patient and eight (8) low risk patients, (iv) two (2) high risk patients and four (4) low risk patients. This risk blending method can be represented by the following equation:

P_{R2}=P_{R2MAX}−P_{R1}(PR_{2MAX}/PR_{1MAX}) (4)
wherein,
P_{R2MAX}=the maximum number of patients the coordinator may be assigned having a risk level of R1;
P_{R1MAX}=the maximum number of patients the coordinator may be assigned having a risk level of R2;
P_{R1}=the number of patients assigned to the coordinator having a risk level of 1; and
P_{R2}=the number of patients that may be assigned to the coordinator having a risk level of 2 given the number of assigned patients having a risk level of 1.

Additional risk levels could be handled similarly by putting the patient load on a consistent risk level basis using the ratios determined by the maximum numbers of patients in each category that the particular medical care coordinator is equipped to handle.

Still another resource allocation decision made by dynamic risk server 71 is the reassigning of the patient to another on call physician (i.e., an on-call physician located remotely from the call center 46). This resource allocation decision depends not only on the medical care giver profile selected for the patient, but also on the schedules and actual profiles of the medical caregivers in call center 46 who serve as medical care coordinators. The physician reassignment may be made in a number of ways. In one example, the patient may be assigned to an on-call physician with a greater degree of specialization based on one of the patient's risk scores, such as by reassigning the patient from an on-call internist to an on-call cardiologist or by assigning the patient to both an on-call cardiologist and an on-call internist. This type of reassignment ensures that the patient will have more rapid access to a physician with a higher degree of specialization in case a consultation is required. In another example, the patient may be assigned to a physician with a different physician/patient ratio. Patients requiring a higher degree of care (as indicated by a relatively higher risk score) may be assigned to an on-call physician with a lower physician/patient ratio to ensure that they receive more attention. In general, the on-call physician will receive alarms for the patient on a physician computer terminal (preferably a tablet, laptop, Smartphone or other mobile device), provide consultation to the patient, place treatment and testing orders for the patient via an EMR order.

In another example, the patient's risk score may be used to determine whether to continuously monitor a video feed of the patient or to only check a video feed of the patient on an ad hoc basis. In accordance with this example, the patient may be provided with a video camera configured to transmit video data to network 22 for receipt by call center server 55. This allows the medical care coordinator assigned to the patient to view the patient at his or her computer terminal 48, 52, 56 in real time. If a patient's risk score increases or surpasses a certain threshold, the frequency at which the medical care coordinator views the video feed of the patient may increase. Examples of the types of risks that could result in allocating continuous video monitoring to a patient include fall risks and seizure risks. In one example, a patient's communication device 32 or physiological data devices 30 may include an accelerometer that indicates the patient exceeds a threshold risk for falling, in which case the patient may be allocated continuous video monitoring by a medical care coordinator at the call center 46.

In another aspect of the present disclosure, risk scores of the type previously may be used to dynamically make treatment decisions and/or to actually issue treatment orders for patients. In one example, the treatment is providing medication to the patient. In another example, the treatment is ordering an interventional procedure (e.g., a cardiac catheterization, angioplasty, or other type of surgical procedure). Referring again to FIG. 4, step 1024 may comprise identifying a patient treatment and/or actually issuing treatment orders (e.g., issuing a prescription to a pharmacy). In preferred examples, the patient risk scores used to identify patient treatments are indicative of one or more medical diagnoses.

The allocation of resources or identification of suitable treatments may be handled in a number of ways by dynamic risk server 71. However, in one example, the risk scores are related to probabilities of medical events and/or medical diagnoses, which are in turn related to particular resource allocations and/or treatments via tables in diagnostic and treatment database 75. An exemplary table that may be provided in diagnostic and treatment database 75 for identifying resource allocations and treatments is illustrated in Table 6 below:

TABLE 6

| | | Probability | | | |
|---|---|---|---|---|---|
| | Probability | of death (a | | Minimum | |
| | (%) of the | medical event) | | patient care | |
| | diagnosis | occurring | Medical | resource | |
| Diagnosis | being correct | within 14 days | treatment | allocation | Procedures |
| Acute | 0-2 | 0-33 | Aspirin 81 mg, | Discharge to | Follow up with |
| Coronary | | | 162 mg, 325 mg | home | primary care |
| Syndrome | | | or treatment for | | physician and |
| | | | alternative | | consider stress |
| | | | diagnoses or no | | testing, |
| | | | treatment | | echocardiogram |
| | | | | | or no further |
| | | | | | testing |
| | | 33-66 | Check | Technologist | Follow up with |
| | | | alternative | monitor with | primary care |
| | | | diagnoses | 50:1 ratio or | physician and |
| | | | | admit to | consider stress |
| | | | | hospital | testing, |
| | | | | | echocardiogram |
| | | | | | or no further |
| | | | | | testing |
| | | 67-100 | Check | Discharge | |
| | | | alternative | from RMM | |
| | | | diagnoses | and admit to | |
| | | | | hospital | |
| Acute | 2-10 | 0-33 | Aspirin | Technologist | Follow up with |
| Coronary | | | 325 mg × 1 | monitor with | primary |
| Syndrome | | | Consider | 50:1 ratio. | physician or |
| | | | controlling blood | | cardiologist |
| | | | pressure and | | RMM Stress test |
| | | | heart rate using | | Echocardiogram |
| | | | betablockers, | | |
| | | | calcium channel | | |
| | | | blockers, ACEIs, | | |
| | | | ARBs, diuretics | | |
| | | 33-66 | Check | Technologist | Follow up with |
| | | | alternative | monitor with | primary |
| | | | diagnoses | 10:1 ratio or | physician RMM |
| | | | | admit to | cardiology |
| | | | | hospital | consult or private |
| | | | | | cardiologist |
| | | | | | RMM Stress test |
| | | | | | Echocardiogram |
| | | 67-100 | Check | Discharge | |
| | | | alternative | from RMM | |
| | | | diagnoses | and admit to | |
| | | | | hospital | |
| Acute | 10-40 | 0-33 | No treatment or | Technologist | Follow up with |
| Coronary | | | Aspirin 325 × 1, | monitor 5:1 | primary |
| Syndrome | | | Plavix 300 mg × 1 | ratio or admit | physician |
| | | | or Prasugrel | to hospital | RMM cardiology |
| | | | 60 mg × 1 or | | consult or private |
| | | | Ticagrelor | | cardiologist |
| | | | 180 mg po × 1 | | RMM Stress test |
| | | | Lovenox 1 mg/ | | RMM |
| | | | kg sc q12, or | | Echocardiogram |
| | | | Heparin 60 U/ | | Schedule |
| | | | kg × 1 then 12 | | outpatient |
| | | | U/kg/h IV | | catheterization or |
| | | | Lipitor 80 mg or | | CT angiogram |
| | | | alternative | | |
| | | | statin +/− 2b3a | | |
| | | | inhibitors | | |
| | | | (abciximab, | | |
| | | | tirofiban, | | |
| | | | eptifibatide) | | |
| | | 33-66 | As above or see | Physician | Follow up with |
| | | | treatments for | monitor 2:1 | primary |
| | | | alternative | ratio or admit | physician RMM |
| | | | diagnoses | to hospital | cardiology |
| | | | | | consult or private |
| | | | | | cardiologist |
| | | | | | RMM Stress test |
| | | | | | RMM |
| | | | | | Echocardiogram |
| | | | | | RMM Cardiology |
| | | | | | Consult |
| | | | | | Schedule |
| | | | | | outpatient |
| | | | | | catheterization or |
| | | | | | CT angiogram |
| | | 67-100 | As above or see | Discharge | |
| | | | treatments for | from RMM | |
| | | | alternative | and admit to | |
| | | | diagnoses | hospital | |
| Acute | 40-70 | 0-100 | No treatment or | Hospital | Transfer to |
| Coronary | | | Aspirin 325 × 1, | Care | hospital |
| Syndrome | | | Plavix 300 mg × 1 | | Urgent |
| | | | or Prasugrel | | revascularization |
| | | | 60 mg × 1 or | | |
| | | | Ticagrelor | | |
| | | | 180 mg po × 1 | | |
| | | | Lovenox 1 mg/ | | |
| | | | kg sc q12, or | | |
| | | | Heparin 60 U/kg | | |
| | | | patient weight × | | |
| | | | 1 then 12 U/ | | |
| | | | kg/h IV | | |
| | | | Lipitor 80 mg or | | |
| | | | alternative | | |
| | | | statin +/− 2b3a | | |
| | | | inhibitors | | |
| | | | (abciximab, | | |
| | | | tirofiban, | | |
| | | | eptifibatide) | | |
| Acute | 70-100 | 0-100 | As above | Hospital | Call 911 from |
| Coronary | | | | Care | call center |
| Syndrome | | | | | Remotely Open |
| | | | | | Cardiac |
| | | | | | Catheterization |
| | | | | | lab |

ACEI = angiotensin converting enzyme (ACE) inhibitor
ARB = angiotensin receptor blocker
×1 = 1 dosage
sc = subcutaneously
IV = intravenously
U = heparin units
q12 = every 12 hours

In the example of Table 6, one or more risk scores calculated for the patient are related to a medical diagnosis of acute coronary syndrome in the diagnostic and treatment database 75. In addition, one or more risk scores are combined to arrive at a probability of death (all cause mortality) in a 14 day period. Table 6 indicates that if the patient has a 0-2% probability of having acute coronary syndrome and a 0-33 percent chance of all cause mortality within 14 days, he should be prescribed aspirin and discharged to home (without remote medical monitoring). In addition, he should follow up with his primary care physician.

At the same medical diagnosis probability (0-2%) and an increased probability of all cause mortality of 33-66 percent within 14 days, the diagnostic and treatment database 75 calls for evaluating alternative diagnoses (i.e., diagnoses that may be the cause of the high death risk), prescribing alternate treatments for the alternate diagnoses, and assigning a call center technologist to the patient who has a 50:1 ratio (patients/technologist). If the probability of death increases to 67-100 percent, the patient is discharged from remote medical management and admitted to a hospital.

The next diagnosis probability row (2-10%) calls for prescribing the listed medications and assigning a call center technologist with a 50:1 patient load capacity (50 patients/technologist) to monitor the patient if the probability of death is 0-33 percent within 14 days. It also calls scheduling a test, in this case ordering an RMM Stress test or echocardiogram for the patient. At the same diagnosis probability, if the probability of death increases to 33-66 percent, alternative diagnoses are evaluated (and alternate treatments are prescribed), and the technologist monitor patient load capacity is modified to 10:1 (patients/technologist). Again, an RMM Stress test or echocardiogram is ordered along with appropriate consultations. If the probability of death increases to 67-100 percent, the patient is discharged from the remote medical management system and transferred to a hospital. No stress echocardiogram is ordered because of its potential impact on the patient's condition, which is presumably fragile given the probability of death. As Table 6 indicates different combinations of medical diagnosis and medical event probabilities call for different resource allocations and/or different treatments. In certain examples, the dynamic risk server 71 or another server will issue actual orders for the identified treatments, procedures, and/or other resource allocations.

As discussed previously with respect to FIG. 4, in some examples a patient's dynamic risk score may be used to determine whether the patient is a suitable candidate for remote medical management. In certain cases, a risk score that is sufficiently high may dictate resource allocations that are not possible with the remote medical management system 20. In such cases, patient care resources may be reallocated by transporting the patient to a treatment facility 31. In certain implementations, the method of FIG. 4 may be modified to determine the probability that patient demand for patient care resources will exceed the available patient care resources, as could occur if too many patients experience concurrent increases in their risk scores.

As indicated previously, patients with higher risk scores are more likely to experience adverse medical events, which may in turn result in liability-related financial losses for the operators of remote medical management system 20. Thus, the risk score may be used to determine whether a particular patient should be subscribed to or unsubscribed from remote medical management system 20. In one example, the following formula is used to determine whether a patient's risk score correlates to a net financial loss for subscribing the patient to remote medical management system 20, in which case the decision may be made not to subscribe him or her:

A=R−C−(P₁*Lₚ₁*L₁)−B (5)
where
R=the future revenue (dollars) that can be generated based on the patient's risk score and insurance billing rates;
C=the patient's expected resource utilization (dollars) while his medical care is managed by remote medical management system 20;
P₁=probability (dimensionless fraction) of an adverse patient outcome based on risk score
Lₚ₁=probability (dimensionless fraction) of an adverse patient outcome being attributed to the remote medical management system 20 in a lawsuit; and
L₁=average settlement (in dollars) of a lawsuit for the adverse outcome associated with P₁;
B=buffer (dollars)

In accordance with the example, values of A≦0 indicate that the patient should not be subscribed to remote medical management system 20, while values of A>0 indicate that the patient should be subscribed. In certain examples, A is calculated on a dynamic continuous basis and may be used to determine if a patient should be transferred to a treatment facility 31 instead of remaining under the supervision of remote call center 46. For example, if decision step 1022 in FIG. 4 yields a NO, patient care resources would be reallocated by transferring the patient to a treatment facility with non-emergent, hospital level resources and (at least temporarily) unsubscribed from the remote medical management system 20. The transfer would effectively free-up patient care resources previously allocated to the transferred patient for deployment to the remaining remote medical management system 20 patient subscribers.

In certain of the examples discussed previously, a risk model is used to generate risk scores for patients. One example of such a risk model is equation (1), above. Because of the large amount of patient data and patient outcome data (i.e., known patient outcomes that can be associated with patient data), it is possible to dynamically modify and improve the risk model on a continuous basis as patient outcome data and patient data are received. Such improvements and modifications may involve selectively including or excluding certain types of patient data for use in calculating risk scores and altering the relationship between a particular piece of patient data and the risk score. With respect to equation (1), for example, the improvements or modifications may involve including or excluding various types of patient data values xᵢ or adjusting the weights wᵢ applied to various types of patient data. The improvements or modifications could also affect the way that a particular piece of patient data is translated to a risk factor xᵢ, or in the case of equations (2) and (3) an incremental risk factor, yᵢ.

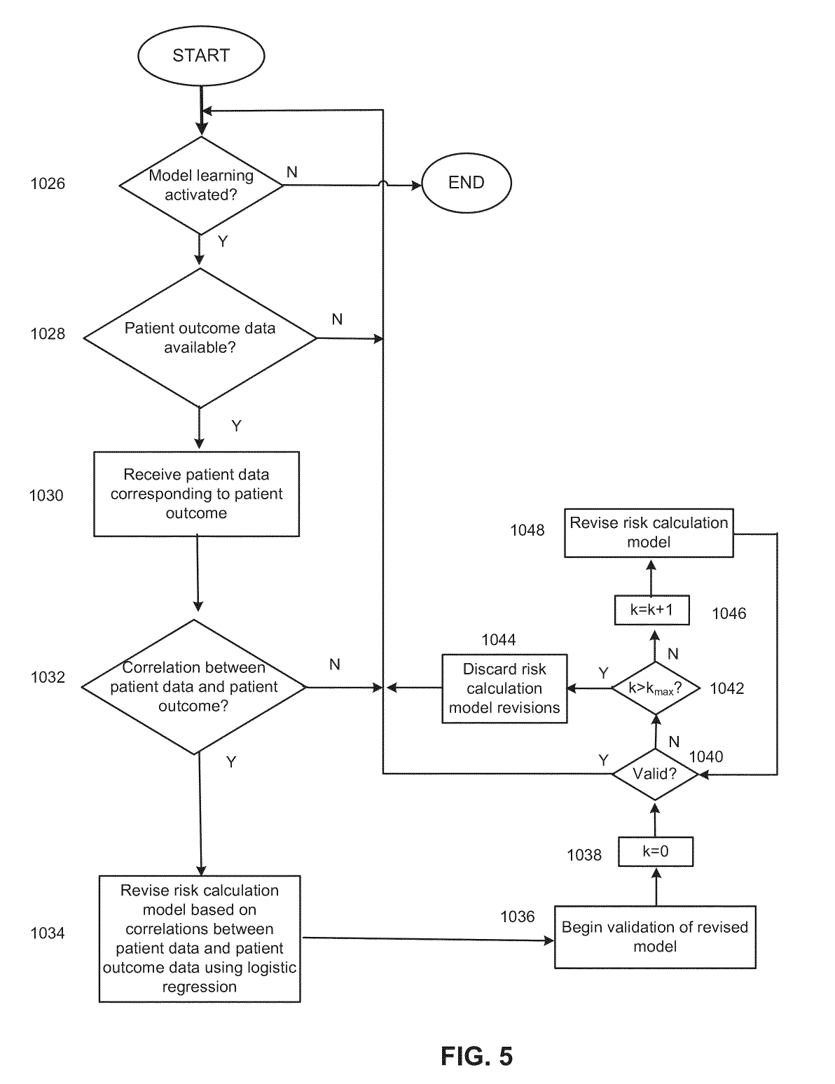

Referring to FIG. 5, a method of dynamically modifying a dynamic a risk model used to calculate patient risk scores is described. The method is preferably computerized and embodied in a set of computer executable process steps stored on a storage device (e.g., hard drive, flash drive, CD-ROM, DVD, etc.). In certain examples, the method can be selectively activated and deactivated by a user. In step 1026 a check is made to determine if risk model learning is activated. If it is not, the method ends. Otherwise, control proceeds to step 1028. A determination is then made as to whether patient outcome data is available for use in updating the dynamic risk model. Certain forms of patient outcome data (e.g., data reflecting patient mortality or the occurrence of other medical events or medical diagnoses) will require manual input into a database. Thus, in certain examples a determination is made as to whether new patient outcome data is available for updating the risk model.

In step 1030 patient data that corresponds to the patient outcome data is identified. For example, a patient's physiological sensor data or laboratory data in a selected time period preceding the medical event reflected in the patient outcome is identified. In accordance with certain examples, the patient outcome data will be translated into a risk score based on a pre-existing correspondence between risk scores and outcomes (e.g., death is assigned 1.0 and survival is assigned 0) reflected in a table stored in diagnostic and treatment database 75. Logistic regression can then be used to determine the correlation between variables (i.e., patient data) that are currently used to calculate dynamic risk scores as well as variables that are not currently used to determine whether and to what extent the variables correlate with the risk scores and actual patient outcomes. Thus, in step 1032 a determination is made as to whether there is a correlation between the various types of patient data and the known patient outcome. If there is a correlation, the risk calculation model is revised accordingly in step 1034. Otherwise, control returns to step 1026.

If the risk calculation model is revised in step 1034, it is preferably then validated in step 1036. In certain examples, the validation step comprises using historical patient outcome data and historic patient data (plus possibly patient care resource data) and determining if the revised risk model yields the expected historical patient outcome data. In the example of FIG. 5, the validation process involves making iterative revisions to the revised risk model as needed to obtain the expected patient outcome data. In step 1038 a counter k is initialized to zero. In step 1040 patient outcomes are predicted using historical patient outcome data with the revised risk calculation model determined in step 1034. If the revised model is deemed valid, control returns to step 1026. Otherwise, in step 1042 a check is made to determine whether the validation counter k has reached its maximum value, kₘₐₓ. If it has, control returns to step 1026. Otherwise, the validation counter is incremented in setup 1046 and the risk model is revised in step 1048 and control returns to step 1040 to determine if the model is now valid. Thus, in the method of FIG. 5 the model maybe revised to achieve validation a number of times (e.g., kₘₐₓ+1 times) after which validation is abandoned. If validation cannot be achieved, in certain examples the risk model modifications are discarded (step 1044) and the model is returned to its form prior to the revisions made in step 1034.

In certain preferred examples, the determination of whether a particular type of patient data should be included in the calculation of risk scores (step 1034) involves determining whether the particular type of patient data is statistically significant. In one example, a particular type of patient data is deemed to be statistically significant if its p-value is less than 0.05, which indicates that the null hypothesis for that patient data should be rejected.

In one example, the logistic regression used to validate a particular risk model is represented by the following equations:

ln(p/(1−p))=C+Σaᵢxᵢ=M (6)

p=e^{M}/(e^{M}+1) (7)
where,
xi are the risk factors, such as those based on patient data or patient care resource data,
ai are the weights for each risk factor xi
C is the regression constant
p is the probability that the event the regression solved for will occur
M represents equation (6)

In certain examples, the dynamic risk model is developed as a baseline model prior to the use of dynamic learning or modification of the type described previously. For example, existing patient outcome probabilities defined by TIMI (thrombolysis in myocardial infarction) or GRACE (global registry of acute coronary events) may be used to generate a baseline model and then modified through the dynamic modification/learning process described above such that TIMI and GRACE derived risk levels will be risk factor inputs themselves to the overall global risk algorithm and each would be weighted accordingly.

The relationships between treatment decisions and procedures and risk scores (or probabilities of medical events or medical diagnoses) reflected in the diagnostic and treatment database 75 may also be dynamically modified based on the foregoing dynamic learning process. In certain cases, medical caregivers may decide to deviate from the treatment and decisions provided in database 75 (e.g., those shown in Table 6) based on their experience, recent research, or other factors. In those cases, the actual treatment decisions and procedures will differ from those called for the diagnostic and treatment database. As a result, actual treatment decisions and procedures may be logically regressed against diagnoses, medical events, and/or risk scores to dynamically modify the treatments and procedures specified by diagnostic and treatment database 75. Thus, tables such as Table 6 (above) may be dynamically altered or modified as actual treatments and procedures are implemented and can be related to risk factors or calculated probabilities of medical diagnoses or medical events occurring.

### Example 1

A patient is subscribed to remote medical management system 20 and assigned a portable ECG sensor (i.e., a type of physiological data device 30 in FIG. 1) and a communication device 32. ECG data is continually generated and transmitted to EMR database 62 (FIG. 2) in real time. Dynamic risk server 71 includes a processor that executes a program which retrieves patient data for the patient from the EMR database 62 on a continual basis such that the server 70 receives it in real time as it is generated by the ECG sensor. Alternatively, dynamic risk server 71 may retrieve data from the EMR database 62, store it on the dynamic risk database 72, and then retrieve the data from dynamic risk database 72 to perform risk score calculations. In either case, the risk score calculations are preferably performed as the ECG sensor data is generated accounting for data transmission delays. The program on dynamic risk server 71 continually calculates a risk score at predetermined intervals such as every second. At the time the patient is first subscribed to the system 20, he is assigned to a technologist at the call center 46. His dynamically calculated risk score at the time of subscription corresponds to two patient outcomes: 1) a 1.8% chance of cardiac death in 14 days, and 2) a 5% chance of cardiac arrhythmia in 14 days. As a result, the patient is deemed not to require frequent human monitoring of his ECG data. Thus, the technologist checks the ECG data on an ad hoc basis.

At one point, the patient's ECG sensor detects flipped (inverted) t-waves relative to previously detected ECG data. Dynamic risk server 71 calculates a new, increased risk score that corresponds to two patient outcomes: 1) an 8% chance of cardiac death in 14 days, and a 16% chance of arrhythmia in 14 days. As a result, the patient care resources for the patient are reallocated so that the technologist in call center 46 to which the patient is assigned begins monitoring the patient's ECG data every 30 minutes.

### Example 2

A group of patients are subscribed to remote medical management system 20. For each patient, dynamic risk server 71 executes a computer program that calculates a patient risk score indicative of a particular patient outcome, in this case, an annual percentage increase in coronary plaque. The group of patients are provided a survey concerning their soda consumption during a treatment period and also have their coronary plaque tested. The method of FIG. 5 is carried out by having a processor in the dynamic risk server 71 execute a set of computer executable instructions stored on a computer readable medium. The instructions use logistical regression to determine whether and to what extent coronary plaque increases correlate with soda consumption. The logistical regression indicates that there is a correlation (i.e., p<0.05) and that the expected coronary plaque increase is 3%/year per unit of daily soda consumption (e.g., 3% plaque increase/soda/day/year, where each soda has a fixed volume). As a result, the risk model is altered to include daily soda consumption as patient lifestyle data that is used to calculate the patient's risk score.

In accordance with certain exemplary systems 20 for providing remote medical management, the total patient care resources available at call center 46 may be monitored on an on-going basis to determine if a capacity limit has been reached. In accordance with one method, a total percent utilization for the call center 46 is calculated by taking the average of all percent utilizations for each medical care coordinator that is currently on-duty (as may be determined by reviewing log in data from the call center database 57. Each medical care coordinator's percent utilization may be calculated by converting the percent utilization for each risk level to a common risk basis equivalent level. For example, a technologist may be qualified to handle three (3) high risk patients and twelve (12) low risk patients. Thus, each high risk patient is equivalent to four low risk patients. If the technologist is assigned two (2) high risk patients and three (3) low risk patients, his percent utilization may be calculated by converting the number of high risk patients (2) to the equivalent number of low risk patients (eight), adding the equivalent number of low risk patients (eight) to the actual number of low risk patients (three) to yield an equivalent total number of low risk patients (11). The equivalent number of low risk patients is then divided by the technologist's maximum number of low risk patients to arrive at the technologist's percent utilization. Thus, in this example the technologist's percent utilization is 11/12 (100)=92%. If the percent utilization values for two other medical care coordinators are 85% and 90%, the total percent utilization for call center 46 would be (92+85+90)/3=89% (if a total of only three medical care coordinators are signed in and on-duty). As a new patient is considered for addition to system 20, the effect on the total percent utilization can be determined, and if adding the patient would exceed the call center capacity, the patient would be rejected.

As the foregoing suggests, each time patient risk scores change, the percent utilization of the call center 46 changes. In accordance with another aspect of the present disclosure, in some exemplary implementations, dynamic risk server 71 will execute a set of computer executable instructions that calculate the probability that a caller will not get through to call center 46. In certain examples, the probability may be used to determine whether to add or remove patient subscribers from remote medical management system 20. In one embodiment, the Engset formula is used to determine the probability that a given call will not get through to call center 46. The formula is as follows:

$${P}_{b} ( N , A , S ) = \frac{{A}^{N} ( \begin{matrix}S \\ N\end{matrix} )}{{\sum }_{i = 0}^{N} {A}^{i} ( \begin{matrix}S \\ i\end{matrix} )} \qquad ( 8 )$$

Where:
   A=offered traffic intensity in Erlangs, from all sources
   S=number of sources of traffic
   N=number of circuits in group
   P_{b} (N,A,S) or P(b)=probability of blocking or congestion

Thus, in one example, in order to subscribe a new patient to system 20, Pb would be no more than 90%, preferably no more than 80%, more preferably no more than 70%, and still more preferably no more than 50%.

It should be noted that an Erlang is related to the call arrival rate (λ) and the average call holding time (h) by the equation Σ=λh, provided that h and λ are expressed using the same units of time (e.g. seconds and calls per second, or minutes and calls per minute). Equation (8) requires recursion to solve for the blocking or congestion probability. There are several recursions that could be used. One way to determine this probability is to first determine an initial estimate. This initial estimate is substituted into the equation and the equation then is solved. The answer to this initial calculation is then substituted back into the equation, resulting in a new answer which is again substituted. This iterative process continues until the equation converges to a stable result.

Engset's equation can therefore be given as follows:

$$\begin{matrix}P ( b ) = \frac{[ \frac{( S - 1 )}{N ! \cdot ( S - 1 - N ) !} ] \cdot {M}^{N}}{{\sum }_{X = 1}^{N} [ \frac{( S - 1 ) !}{X ! \cdot ( S - 1 - X ) !} ] \cdot {M}^{X}} & ( 9 ) \\ M = \frac{A}{S - A \cdot ( 1 - P ( b ) )} & ( 10 )\end{matrix}$$

What is claimed is:

1. A system for determining the probability of a patient outcome occurring, the system comprising:
a patient data database;
a patient care resource database;
at least one processor programmed to execute a set of computer executable instructions that perform the following steps when executed:
receive patient data from the patient data database for a plurality of patients;
receive patient care resource data for the plurality of patients; and
calculate a risk score for each patient in the plurality of patients based on the patient data and the patient care resource data, wherein the risk score is indicative of the likelihood of a patient outcome occurring.

2. The system of claim 1, wherein the patient outcome is a medical event.

3. The system of claim 2, wherein the medical event is death.

4. The system of claim 1, wherein the patient outcome is a medical diagnosis.

5. The system of claim 1, wherein the patient data comprises patient medical data.

6. The system of claim 5, wherein the patient medical data comprises patient physiological sensor data, and the step of receiving patient data for a plurality of patients comprises receiving the patient sensor data in real time from patient physiological sensors.

7. The system of claim 1, wherein the patient data comprises patient laboratory test data.

8. The system of claim 1, wherein the step of calculating a risk score for each patient comprises continuously calculating a risk score for each patient at an interval.

9. A system for dynamically allocating patient care resources to patients located remotely from the patient care resources, comprising:
the system for determining the probability of a patient outcome occurring of claim 1, wherein the patient outcome is a medical event; and
a diagnosis and treatment database, wherein when executed the set of computer executable instructions perform the further step of identifying an allocation of the patient care resources to each patient based at least in part on the patient's risk score indicative of the probability of the medical event.

10. The system of claim 9, wherein the patient care resource database comprises medical caregiver profile data for a plurality of medical caregivers, and the step of identifying an allocation of the patient care resources to each patient from the treatment and diagnosis database comprises identifying medical caregiver profile data based at least in part of the patient's risk score.

11. The system of claim 10, wherein the medical caregiver profile data is indicative of whether the medical caregiver is a doctor, nurse, or technologist.

12. The system of claim 10, wherein when executed the set of computer executable instructions further identify a medical care coordinator having the identified medical caregiver profile.

13. The system of claim 9, wherein the patient care resources are located at a centralized call center, and when executed the computer executable instructions perform the further step of determining the probability that patient demand for the patient care resources will exceed available patient care resources.

14. The system of claim 9, wherein the step of identifying an allocation of patient care resources to each patient from the diagnosis and treatment database comprises determining whether to provide real time human monitoring of a patient's medical data.

15. The system of claim 9, wherein the step of identifying an allocation of patient care resources to each patient comprises determining whether to assign an on-call specialist to monitor a patient.

16. The system of claim 9, wherein the step of identifying an allocation of patient care resources to each patient comprises determining a frequency of human monitoring of patient medical data for a patient.

17. The system of claim 1, wherein the step of calculating a risk score is based on a risk score model, and when executed the computer executable instructions perform the further step of dynamically modifying the risk score model based on patient data and known patient outcome data corresponding to the patient data.

18. A system for dynamically treating patients, comprising:
the system for determining the probability of a patient outcome occurring of claim 1, wherein the patient outcome is a medical diagnosis; and
a diagnosis and treatment database, wherein when executed the set of computer executable instructions perform the further step of identifying a treatment in the diagnosis and treatment database based at least in part on the patient's risk score indicative of the probability of the medical diagnosis.

19. The system of claim 18, wherein the treatment comprises one or more medications.

20. The system of claim 18 wherein the step of identifying a treatment in the diagnosis and treatment database based at least in part on the patient's risk score indicative of the probability of the medical diagnosis is based on a relationship between the treatment and the probability of the medical diagnosis specified in the diagnostic and treatment database and when executed the computer executable instructions dynamically modify the relationship based on patient data and actual treatment data corresponding to the patient data.

21. A computerized method of dynamically allocating patient care resources to a plurality of patients located remotely from the patient care resources, wherein the patient care resources include medical care coordinators, the method comprising:
receiving patient data for the plurality of patients;
executing a set of computer executable instructions to perform the following steps:
calculate a risk score for each patient in the plurality of patients based on the patient data, wherein each risk score is indicative of the likelihood of a patient outcome occurring; and
identify an allocation of the patient care resources to each patient based at least in part on the patient's risk score.

22. The computerized method of claim 21, further comprising receiving patient care resource data, wherein the step of executing a set of computer executable instructions to calculate a risk score for each patient is further based on the patient care resource data.

23. The computerized method of claim 21, wherein the risk score is indicative of a probability of a medical event occurring.

24. The computerized method of claim 23, wherein the medical event is death.

25. The computerized method of claim 21, wherein the patient outcome is a medical diagnosis.

26. The computerized method of claim 21, wherein the patient data comprises patient medical data.

27. The computerized method of claim 26, wherein the patient medical data comprises patient physiological sensor data, and the step of receiving patient data for a plurality of patients comprises receiving the patient physiological sensor data in real time from patient sensors.

28. The computerized method of claim 21, wherein the step of calculating a risk score for each patient comprises continuously calculating a risk score for each patient at an interval.

29. The computerized method of claim 21, wherein the step of calculating a risk score is based on a risk score model, and the steps performed by executing the set of computer executable instructions further comprises dynamically modifying the risk score model based on the patient data and known patient outcome data corresponding to the patient data.

30. The computerized method of claim 21, wherein the step of identifying an allocation of patient care resources comprises identifying a medical caregiver profile.

31. The computerized method of claim 21, further comprising allocating each patient's identified patient care resources to each patient.

32. A computerized method of dynamically treating patients, the method comprising:
receiving patient data for the plurality of patients;
executing a set of computer executable instructions to perform the following steps:
calculate a risk score for each patient in the plurality of patients based on the patient data, wherein each risk score is indicative of the likelihood of a patient outcome occurring; and
identify a treatment for each patient based at least on the patient's risk score.

33. The computerized method of claim 32, further comprising receiving patient care resource data, wherein the step of calculating a risk score for each patient in the plurality of patients based on the patient data is further based on the patient care resource data.

34. The computerized method of claim 32, wherein the risk score is indicative of a probability of a medical event occurring.

35. The computerized method of claim 34, wherein the medical event is death.

36. The computerized method of claim 32, wherein the patient outcome is a medical diagnosis.

37. The computerized method of claim 32, wherein the patient data comprises patient medical data.

38. The computerized method of claim 37, wherein the patient medical data comprises patient physiological sensor data, and the step of receiving patient data for a plurality of patients comprises receiving the patient physiological sensor data in real time from patient sensors.

39. The computerized method of claim 32, wherein the step of calculating a risk score for each patient comprises continuously calculating a risk score for each patient at an interval.

40. The computerized method of claim 32, wherein the step of calculating a risk score is based on a risk score model, and when executed the set of computer executable instructions performs the further step of dynamically modifying the risk score model based on patient data and known patient outcome data corresponding to the patient data.

41. The computerized method of claim 32 wherein the treatment is a medication.

42. The computerized method of claim 32 further comprising the step of providing each patient's identified treatment to each patient.
